(19) United States
(12) Patent Application Publication
(10) Pub. No.: US 2010/0089075 A1
(43) Pub. Date: Apr. 15, 2010

(54) Refrigerator with icemaker and control method thereof

(75) Inventor: Young Gwi Park, Gwangsan (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/385,261

(22) Filed: Apr. 2, 2009

(30) Foreign Application Priority Data
Oct. 9, 2008 (KR) 10-2008-99256

(51) Int. Cl. F25C 1/00; F25D 11/00; G05D 23/00

(52) U.S. Cl. 62/66; 62/440; 62/157

(57) ABSTRACT

A refrigerator to provide information of completion of an ice making operation performed in an ice making container or ice separating information via an electric unit thereof is provided. Completion of the ice making operation is determined based on a temperature of a storage compartment and/or an ice making time. Providing information of completion of the ice making operation or ice separating information allows a user to easily know completion of the ice making operation so that the user can conveniently separate ice cubes from the ice making container at an appropriate time, and prevents unwanted conglomeration of ice cubes stored in an ice storage container due to insufficient ice making. Further, when the ice cubes are automatically separated from the ice making container, the electric unit of the refrigerator provides information informing the user that an ice separating operation is being performed.

### CROSS-REFERENCE TO RELATED APPLICATIONS

This application claims the benefit of Korean Patent Application No. 2008-0099256, filed on Oct. 9, 2008 in the Korean Intellectual Property Office, the disclosure of which is incorporated herein by reference.

### BACKGROUND

1. Field

The present invention relates to a refrigerator and a control method thereof, and, more particularly, to a refrigerator having an icemaker to freeze water into ice cubes and a control method thereof.

2. Description of the Related Art

Generally, a refrigerator is an apparatus where food in a storage compartment is stored in a frozen or refrigerated state by evaporation heat of a refrigerant undergoing a cooling cycle. The refrigerator has a food storage compartment defined in a body, and the food storage compartment is divided into a freezing compartment in which food is frozen and stored and a refrigerating compartment in which food is refrigerated and stored. The freezing compartment is provided with an icemaker to freeze water into ice cubes using cold air in the freezing compartment. The freezing compartment is further provided with a storage container in which ice cubes made in the icemaker are stored.

The icemaker may be basically classified into a manual icemaker and an automatic icemaker. In the manual icemaker, ice cubes are separated from an ice making container via rotation of a handle, whereas in the automatic icemaker, ice cubes are separated from an ice making container by inverting the ice making container via rotation of a motor.

In both the icemakers, ice making is performed immediately after water is fed into the ice making container. After completing the ice making according to the passage of a predetermined time, the ice making container is rotated to put ice cubes in the storage container.

However, in the case of a refrigerator having the manual icemaker, it is difficult for a user to know when ice making is completed or to know when the user has to perform ice separation. Moreover, if the user performs ice separation prematurely despite insufficient ice making, it causes water remaining in the ice making container to be poured into the storage container in which ice cubes, which are previously made, are stored. Furthermore, in the case of a refrigerator having the automatic icemaker, noises caused upon separation of ice cubes in a state where the user cannot expect when the ice cubes are separated may be unpleasant to the user.

### SUMMARY

Aspects and/or advantages will be set forth in part in the description which follows and, in part, will be obvious from the description, or may be learned by practice of the invention.

The foregoing and/or other aspects are achieved by providing a refrigerator, including: a storage compartment to store foodstuffs to be cooled; an ice making container mounted in the storage compartment and configured to an ice making operation; a controller determining whether or not the ice making operation is completed; and an electric unit providing information of completion of the ice making operation or ice separating information when the ice making operation is determined to be completed.

The refrigerator may further include: an input part receiving a water feed event signal; and a temperature sensor sensing a temperature of the storage compartment, wherein, when the water feed event signal is transmitted from the input part to the controller, the controller determines whether or not the ice making operation is completed based on at least one of an ice making time required to perform the ice making operation and the sensed temperature of the storage compartment.

The refrigerator may further include: a water feeder to feed water into the ice making container; and a temperature sensor sensing a temperature of the storage compartment, wherein the controller determines whether or not feeding of water is performed, and after completion of feeding of water, determines whether or not the ice making operation is completed based on at least one of an ice making time required to perform the ice making operation and the sensed temperature of the storage compartment.

The electric unit may include: a sound generator audibly providing information of completion of the ice making operation or ice separating information; and a display visually providing information of completion of the ice making operation or ice separating information.

The foregoing and/or other aspects are achieved by providing a refrigerator including: a storage compartment to store foodstuffs to be cooled; an ice making container mounted in a storage compartment and configured to perform an ice making operation; a water feeder to feed water into the ice making container; a temperature sensor sensing a temperature of the storage compartment; a controller determining whether or not feeding of water is performed, and after completion of feeding of water, determining whether or not the ice making operation is completed based on at least one of an ice making time required to perform the ice making operation and the sensed temperature of the storage compartment; and an electric unit providing information of completion of the ice making operation or ice separating information when the ice making operation is determined to be completed.

The refrigerator may further include: a drive unit performing an ice separating operation of the ice making container when the ice making operation is determined to be completed.

The foregoing and/or other aspects are achieved by providing a refrigerator including: a storage compartment to store foodstuffs to be cooled; an ice making container mounted in the storage compartment and configured to perform an ice making operation; a controller determining whether or not the ice making operation is completed; a drive unit performing an ice separating operation of the ice making container when the ice making operation is determined to be completed; and an electric unit providing ice separating information during implementation of the ice separation operation.

The foregoing and/or other aspects are achieved by providing a control method of a refrigerator including: feeding water into an ice making container mounted in a storage compartment; performing an ice making operation in the ice making container; determining whether or not the ice making operation is completed; and providing information of completion of the ice making operation or ice separating information when the ice making operation is determined to be completed.

The determination of completion of the ice making operation may include: sensing a temperature of the storage compartment; and determining completion of the ice making operation based on at least one of the sensed temperature of the storage compartment and an ice making time required to perform the ice making operation.

The ice making time may start from a time when completion of the feeding of water is determined.

The feeding of water may include determining whether or not the feeding of water is completed based on the input of a water feed event signal.

The feeding of water may include determining completion of the feeding of water when a time required to perform the feeding of water passes a preset time.

The foregoing and/or other aspects are achieved by providing a control method of a refrigerator including: feeding water into an ice making container mounted in a storage compartment; performing an ice making operation in the ice making container; sensing a temperature of the storage compartment; determining whether or not the ice making operation is completed based on at least one of an ice making time required to perform the ice making operation and the sensed temperature of the storage compartment; and providing information of completion of the ice making operation or ice separating information when the ice making operation is determined to be completed.

The control method may further include: performing an ice separating operation of the ice making container when the ice making operation is determined to be completed.

The feeding of water may be performed for a preset time.

The ice making time may start from a time when the feeding of water is completed.

The temperature of the storage compartment may be a temperature sensed at a position adjacent to the ice making container.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an illustration of a refrigerator according to one embodiment;

FIG. 2 is a detailed illustration of an icemaker provided in the refrigerator according to one embodiment;

FIG. 3 is a control block diagram of the refrigerator according to one embodiment;

FIG. 4 is a control flowchart of the refrigerator according to one embodiment;

FIG. 5 is an illustration of a refrigerator according to another embodiment;

FIG. 6 is a control block diagram of the refrigerator according to another embodiment; and

FIG. 7 is a control flowchart of the refrigerator according to another embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

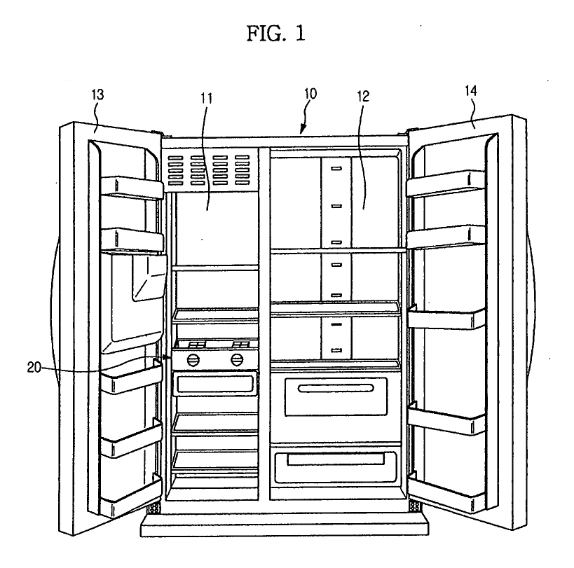

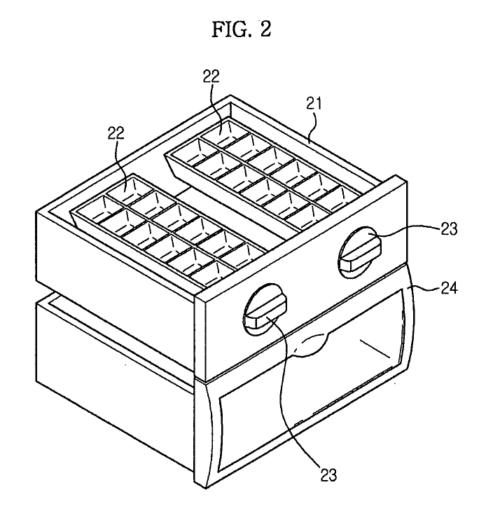

FIG. 1 is an illustration of a refrigerator according to one embodiment, and FIG. 2 is a detailed illustration of an icemaker provided in the refrigerator according to one embodiment.

The refrigerator includes a body 10 having an open front side, and a storage compartment defined in the body 10, in which food is stored in a frozen or refrigerated state. The storage compartment is divided into left and right compartments with a partition interposed therebetween. The divided storage compartments include a freezing compartment 11 in which food is frozen and stored and a refrigerating compartment 12 in which food is refrigerated and stored.

The freezing compartment 11 and refrigerating compartment 12 have open front sides, and doors 13 and 14 are provided, respectively, at the open front sides of the freezing compartment 11 and refrigerating compartment 12 to shield both the freezing and refrigerating compartments 11 and 12 from the outside. An icemaker 20 is built into the freezing compartment 11 to feed ice cubes to a user.

The icemaker 20 includes an ice making frame 21, an ice making container 22 received inside the ice making frame 21 in which water is frozen into ice cubes, and an ice separator 23 connected to a rotating shaft of the ice making container 22. The icemaker 20 further includes an ice storage container 24 installed below the ice making frame 21, in which ice cubes separated from the ice making container 22 are received. If water fed into the ice making container 22 of the icemaker 20 is completely frozen into ice cubes, the user directly rotates the ice separator 23 to invert the ice making container 22, allowing the ice cubes to be separated from the ice making container 22 and to be dropped into the ice storage container 24 therebelow. The ice making frame 21 and ice storage container 24 of the icemaker 20 are able to be put into or taken out of the freezing compartment 11 like a drawer.

Feeding of water into the ice making container 22 of the icemaker 20 may be implemented as the user directly feeds water into the ice making container 22, or as a water feeder (not shown) is provided above the ice making container 22.

In this case, the water feeder (not shown) includes an exterior water source, a water feed tube installed to feed water from the water source into the ice making container 22, and a water feed valve to control the flow of water fed from the water source, the water feed valve being opened for a preset time to feed a predetermined amount of water into the ice making container 22.

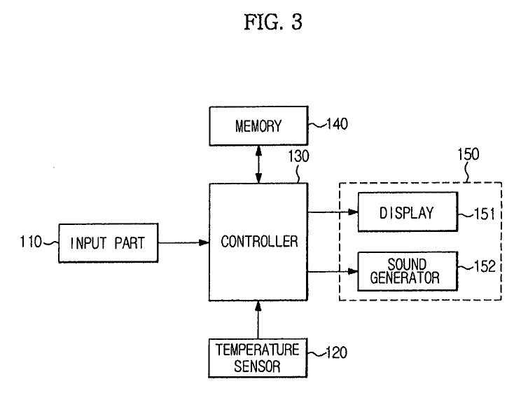

FIG. 3 is a control block diagram of the refrigerator according to one embodiment. A control mechanism of the refrigerator includes an input part 110, a temperature sensor 120, a controller 130, a memory 140, and an electric unit 150. This will now be described with reference to FIGS. 1 and 2.

The input part 110 is provided at one of the doors 12 and 13 of the refrigerator and is manually operated in such a manner to transmit a signal, input by the user, to the controller 130. More specifically, if the user manipulates a water feed completion button (not shown) after feeding water into the ice making container 22, the input part 110 receives a water feed event signal from the user, transmitting the water feed event signal to the controller 130.

The temperature sensor 120 is provided in the storage compartment containing the icemaker 20, i.e. in the freezing compartment 11. The temperature sensor 120 serves to sense an interior temperature of the freezing compartment 11 and then to transmit the sensed interior temperature of the freezing compartment 11 to the controller 130. In this case, the interior temperature of the freezing compartment 11 is used to determine whether or not water received in the ice making container 22 is completely frozen into ice cubes. Accordingly, the temperature sensor 120 may be arranged adjacent to the ice making container 22.

The controller 130 has a function to count an ice making time from a time when water is completely fed into the ice making container 22. Accordingly, the controller 130 is able to determine whether or not the water received in the ice making container 22 is completely frozen into ice cubes, on the basis of at least one of the ice making time and the sensed interior temperature of the freezing compartment 11 transmitted from the temperature sensor 120.

If the controller 130 determines that the water received in the ice making container 22 is completely frozen into ice cubes, the controller 130 controls operation of the electric unit 150 to provide information of completion of ice making. More specifically, if the controller 130 determines the completion of ice making, the controller 130 controls operations of a display 151 and a sound generator 152 to visually and audibly output ice separating information informing the user that they may now separate ice cubes.

The memory 140 serves to store data of completion time of ice making corresponding to the interior temperature of the freezing compartment 11, data of completion time of ice making corresponding to the ice making time, or data of completion time of ice making corresponding to a correlation between the interior temperature of the freezing compartment and the ice making time. That is, the memory 140 stores data to assist the controller 130 to determine completion of ice making.

The electric unit 150 serves to inform of operating conditions of the refrigerator, and includes the display 151 and sound generator 152. The display 151 provides information of completion of ice making, in text or icon form, according to an instruction of the controller 130. The display 151 also provides ice separating information informing the user that the user may now separate the ice cubes. The sound generator 152 outputs a bell sound or melody, for example, according to an instruction of the controller 130, to allow the user to know the completion of ice making. The sound generator 152 may also output audible ice separating information informing the user that the user may now separate ice cubes.

In the above description, feeding water into the ice making container 22 by the user is described, but automatically feeding water into the ice making container 22 is also possible. The automatic feeding of water into the ice making container 22 is as follows.

The refrigerator is provided with a water feeder. Under the control of the controller 130, the water feeder is operated in such a manner as to feed water into the ice making container 22 for a preset time. If the preset time passes, the controller 130 determines completion of the feeding of water, and counts a time required to perform ice making (i.e. an ice making time).

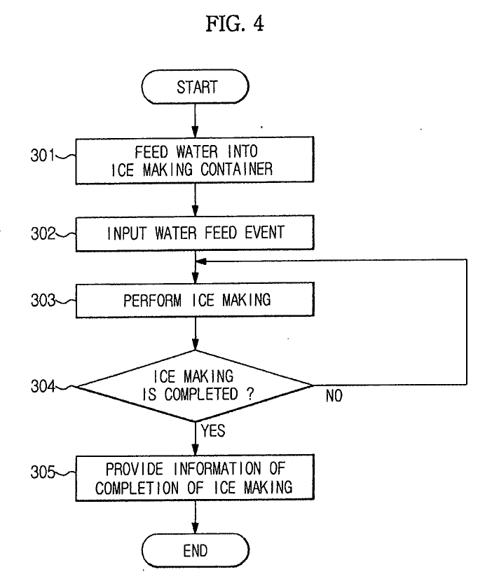

FIG. 4 is a control flowchart of the refrigerator according to an embodiment. Now, a control method of the refrigerator by the controller 130, which is capable of easily recognizing whether or not water received in the ice making container is completely frozen into ice cubes, will be described.

In the case where the refrigerator is provided with the water feeder, the controller 130 controls the water feeder to feed water into the ice making container for a preset time. If the preset time passes, the controller 130 determines the completion of ice making and counts an ice making time.

In the case where the refrigerator has no water feeder, if the user manipulates the water feed completion button (not shown) of the input part 110 after directly feeding water into the ice making container 22 (at 301), the controller 130 receives a water feed event signal, which informs of the completion of feeding of water, input from the input part 110 (at 302), and counts an ice making time while causing the water received in the ice making container 22 to be frozen into ice cubes (at 303).

In this case, the temperature sensor 120 periodically senses the interior temperature of the storage compartment in which the ice making container 22 is provided, i.e. the interior temperature of the freezing compartment 11. Accordingly, on the basis of at least one of the interior temperature of the freezing compartment 11 periodically transmitted from the temperature sensor 120 and the measured ice making time, the controller 130 determines whether or not the water in the ice making container 22 is completely frozen into ice cubes (at 304).

Here, the interior temperature of the freezing compartment 11 is used to determine whether or not the water received in the ice making container is completely frozen into ice cubes. Accordingly, the interior temperature of the freezing compartment 11 may be sensed at a position adjacent to the ice making container 22.

If completion of ice making using the water in the ice making container 22 is determined, the electric unit 150 is controlled to provide information of completion of ice making (at 305). That is, the display 151 visually outputs information of completion of ice making, and the sound generator 152 audibly outputs information of completion of ice making. In this case, the display 151 displays information of completion of ice making in text or icon form, and the sound generator 152 outputs a bell sound or melody informing completion of ice making. If ice making is not completed, the process returns to operation 303.

As the display 151 and sound generator 152 of the refrigerator output information of the completion of ice making when the water in the ice making container 22 of the icemaker 20 is completely frozen into ice cubes, the user can easily know completion of ice making, and separate the ice cubes at an appropriate time after the icemaker 20 completely freezes the water into the ice cubes. Separating the ice cubes at an appropriate time after completion of ice making can assure convenient separation of ice cubes from the icemaker 20 without a risk of conglomeration of the ice cubes when the ice cubes are stored in the ice storage container. In addition, the appropriate separation of ice cubes is economical because it requires no separate configuration and addition of manufacturing costs therefor.

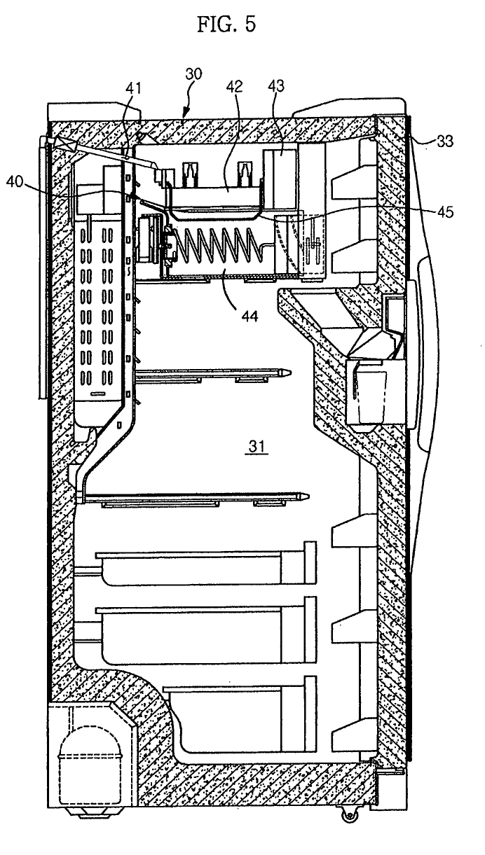

FIG. 5 is an illustration of a refrigerator according to another embodiment.

The body 30 of the refrigerator contains a freezing compartment 31 and a refrigerating compartment. A door 33 is installed at a front side of the freezing compartment 31 to open or close the freezing compartment 31. An icemaker 40 is provided in the freezing compartment 31. The freezing compartment 31 is further provided with a water feeder to feed water into the icemaker 40.

Here, the water feeder includes an exterior water source, a water feed tube 41 installed to feed water from the water source into an ice making container 42, and a water feed valve to control flow of water from the water source, the water feed valve being opened for a preset time to feed a predetermined amount of water into the ice making container 42.

The icemaker 40 includes the ice making container 42 in which the water fed from the water feed tube 41 is received. In this case, the ice making container 42 is pivotally rotatable by a motor 43. When the ice making container 42 is inverted by a rotating force of the motor 43, automatic separation of ice cubes from the ice making container 42 is possible. The icemaker 40 further includes an ice storage container 44 in which ice cubes made in the ice making container 42 are stored, and an ice sensing lever 45 to sense whether or not the ice storage container 44 is full of ice cubes.

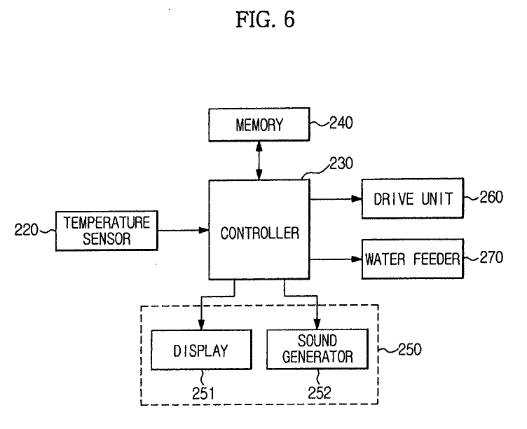

FIG. 6 is a control block diagram of the refrigerator according to another embodiment. A control mechanism of the refrigerator includes a temperature sensor 220, a controller 230, a memory 240, an electric unit 250, a drive unit 260, and a water feeder 270. This will be described with reference to FIG. 5.

The temperature sensor 220 is provided in the storage compartment containing the icemaker 40, i.e. in the freezing compartment 31. The temperature sensor 220 senses an interior temperature of the freezing compartment 31 and then transmits the sensed interior temperature of the freezing compartment 31 to the controller 230. In this case, the interior temperature of the freezing compartment 31 is used to determine whether or not water received in the ice making container 42 is completely frozen into ice cubes. Accordingly, the temperature sensor 220 may be arranged adjacent to the ice making container 42.

The controller 230 controls operation of the water feeder 270 to feed water into the ice making container 22 for a preset time. If the preset time passes, the controller 230 determines the completion of feeding of water, and counts an ice making time. Accordingly, the controller 230 is able to determine whether or not the water received in the ice making container 42 is completely frozen into ice cubes on the basis of at least one of the ice making time and the sensed interior temperature of the freezing compartment 31 transmitted from the temperature sensor 220.

If it is determined that water received in the ice making container 42 is completely frozen into ice cubes, the controller 230 controls operation of the drive unit 260 to rotate the ice making container 42, thereby allowing the ice cubes to be automatically separated from the ice making container 42. Then, the controller 230 controls operation of the electric unit 250, to provide ice separating information via the electric unit 250. That is, the controller 230 controls a display 251 and a sound generator 252 to visually and audibly output ice separating information.

The memory 240 stores data of the completion time of ice making corresponding to the interior temperature of the freezing compartment 31, data of the completion time of ice making corresponding to the ice making time, or data of the completion time of ice making corresponding to a correlation between the interior temperature of the freezing compartment 31 and the ice making time. That is, the memory 240 stores data to assist the controller 230 to determine the completion of ice making.

The electric unit 250 provides operating conditions of the refrigerator, and includes the display 251 and sound generator 252. The display 251 provides ice separating information, in text or icon form, according to an instruction of the controller 230. The sound generator 252 outputs a bell sound or melody, for example, according to an instruction of the controller 230 to allow the user to recognize implementation of an ice separating operation.

The drive unit 260 rotates the motor 43 according to an instruction of the controller 230 if the water in the ice making container 42 is completely frozen into ice cubes, to rotate the ice making container 42, thereby allowing the ice cubes to be automatically dropped into the ice storage container 44. The water feeder 270 receives water fed from the exterior water source according to an instruction of the controller 230 after separation of ice cubes from the ice making container 42 is completed, to feed the water into the ice making container 42 for a preset time.

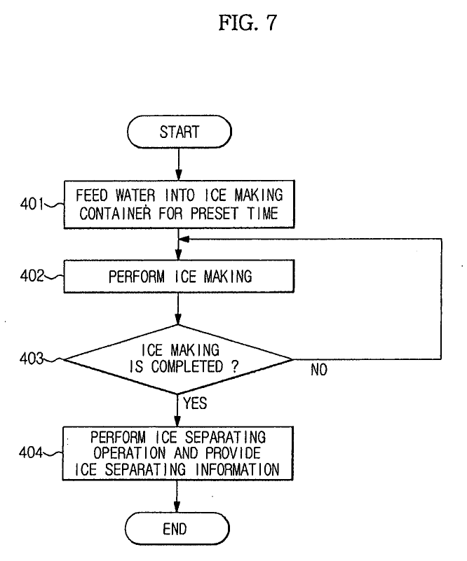

FIG. 7 is a control flowchart of the refrigerator according to another embodiment. Now, a control method of the refrigerator by the controller 230, which is capable of easily recognizing whether or not an operation to separate ice cubes from the ice making container is being performed, will be described.

The water feed valve is opened for a preset time to feed water into the ice making container 42 for the preset time (at 401). If the preset time passes, the water feed valve is closed and the controller 230 determines completion of feeding of water. From a time when completion of ice making is determined, the controller 230 counts an ice making time while causing the water received in the ice making container 42 to be frozen into ice cubes (at 402).

Subsequently, the temperature sensor 220 periodically senses the interior temperature of the storage compartment in which the ice making container 42 is provided, i.e. the interior temperature of the freezing compartment 31. Accordingly, on the basis of at least one of the interior temperature of the freezing compartment 31 periodically transmitted from the temperature sensor 220 and the measured ice making time, the controller 230 determines whether or not the water in the ice making container 42 is completely frozen into ice cubes (at 403).

Here, the interior temperature of the freezing compartment 31 is used to determine whether or not the water received in the ice making container 42 is completely frozen into ice cubes. Accordingly, the interior temperature of the freezing compartment 31 may be sensed at a position adjacent to the ice making container 42.

When the completion of ice making using the water in the ice making container 42 is determined, the drive unit 260 is operated via rotation of the motor 43 to rotate the ice making container 42, enabling implementation of an ice separating operation to separate the ice cubes from the ice making container 42. Then, the electric unit 250 is controlled to provide ice separating information (at 404). Specifically, the display 251 displays the ice separating information in text or icon form, and the sound generator 252 outputs a bell sound or melody, for example, informing separation of ice cubes. When it is determined ice making is not completed, the process returns to 402 until the completion of ice making is determined.

After completion of the ice separating operation, the water feeder 270 again receives water from the exterior water source and feeds the water into the ice making container 42 for a preset time.

As a result of generating ice separating information via the display and sound generator of the electric unit during separation of ice cubes from the icemaker, the user can easily know that the ice separating operation is being performed.

As is apparent from the above description, according to one aspect of the present embodiments, if water in an ice making container is completely frozen into ice cubes, an electric unit provided at a refrigerator provides information of completion of ice making and ice separating information, allowing a user to easily know completion of ice making and to separate the ice cubes from the ice making container at an appropriate time upon completion of ice making. This can prevent conglomeration of the ice cubes when the ice cubes are stored in an ice storage container, and also, assures convenient ice separating operation.

According to another aspect of the present embodiments, during separation of the ice cubes from the ice making container, the electric unit provided at the refrigerator provides ice separating information, allowing the user to easily know that the ice separating operation is being performed.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator, comprising:
a storage compartment to store foodstuffs to be cooled;
an ice making container mounted in the storage compartment and configured to perform an ice making operation;
a controller determining whether or not the ice making operation is completed; and
an electric unit providing information of completion of the ice making operation or ice separating information when the ice making operation is determined to be completed.

2. The refrigerator according to claim 1, further comprising:
an input part receiving a water feed event signal; and
a temperature sensor sensing a temperature of the storage compartment,
wherein, when the water feed event signal is transmitted from the input part to the controller, the controller determines whether or not the ice making operation is completed based on at least one of an ice making time required to perform the ice making operation and the sensed temperature of the storage compartment.

3. The refrigerator according to claim 1, further comprising:
a water feeder to feed water into the ice making container; and
a temperature sensor sensing a temperature of the storage compartment,
wherein the controller determines whether or not feeding of water is performed, and after completion of feeding of water, determines whether or not the ice making operation is completed based on at least one of an ice making time required to perform the ice making operation and the sensed temperature of the storage compartment.

4. The refrigerator according to claim 1, wherein the electric unit includes:
a sound generator audibly providing information of completion of the ice making operation or ice separating information; and
a display visually providing information of completion of the ice making operation or ice separating information.

5. A refrigerator, comprising:
a storage compartment to store foodstuffs to be cooled;
an ice making container mounted in the storage compartment and configured to perform an ice making operation;
a water feeder to feed water into the ice making container;
a temperature sensor sensing a temperature of the storage compartment;
a controller determining whether or not feeding of water is performed, and after completion of feeding of water, determining whether or not the ice making operation is completed based on at least one of an ice making time required to perform the ice making operation and the sensed temperature of the storage compartment; and
an electric unit providing information of completion of the ice making operation or ice separating information when the ice making operation is determined to be completed.

6. The refrigerator according to claim 5, further comprising:
a drive unit performing an ice separating operation of the ice making container when the ice making operation is completed.

7. A refrigerator, comprising:
a storage compartment to store foodstuffs to be cooled;
an ice making container mounted in the storage compartment and configured to perform an ice making operation;
a controller determining whether or not the ice making operation is completed;
a drive unit performing an ice separating operation of the ice making container when the ice making operation is determined to be completed; and
an electric unit providing ice separating information during implementation of the ice separation operation.

8. A control method of a refrigerator, comprising:
feeding water into an ice making container mounted in a storage compartment;
performing an ice making operation in the ice making container;
determining whether or not the ice making operation is completed; and
providing information of completion of the ice making operation or ice separating information when the ice making operation is determined to be completed.

9. The method according to claim 8, wherein the determination of completion of the ice making operation includes:
sensing a temperature of the storage compartment; and
determining completion of the ice making operation based on at least one of the sensed temperature of the storage compartment and an ice making time required to perform the ice making operation.

10. The method according to claim 9, wherein the ice making time starts from a time when completion of the feeding of water is determined.

11. The method according to claim 8, wherein the feeding of water includes determining whether or not the feeding of water is completed based on the input of a water feed event signal.

12. The method according to claim 8, wherein the feeding of water includes determining completion of the feeding of water when a time required to perform the feeding of water passes a preset time.

13. A control method of a refrigerator comprising:
feeding water into an ice making container mounted in a storage compartment of the refrigerator;
performing an ice making operation in the ice making container;
sensing a temperature of the storage compartment;
determining whether or not the ice making operation is completed based on at least one of an ice making time required to perform the ice making operation and the sensed temperature of the storage compartment; and
providing information of completion of the ice making operation or ice separating information when the ice making operation is determined to be completed.

14. The method according to claim 13, further comprising:
performing an ice separating operation of the ice making container when the ice making operation is completed.

15. The method according to claim 13, wherein the feeding of water is performed for a preset time.

16. The method according to claim 13, wherein the ice making time starts to be counted from a time when the feeding of water is completed.

17. The method according to claim 13, wherein the temperature of the storage compartment is a temperature sensed at a position adjacent to the ice making container.
